(19) United States
(12) Patent Application Publication
(10) Pub. No.: US 2021/0025427 A1
(43) Pub. Date: Jan. 28, 2021

(54) CONNECT STRUCTURE OF A TRADITIONAL THREAD AND AN INTERNAL THREAD OUTLINING A BIDRECTIONAL TAPERED DUMBBELL SHAPE HAVING A LAGER LEFT-END CONICAL DEGREE

(71) Applicant: AMICUS VERITATIS MACHINERY CO., LTD., Taizhou (CN)

(72) Inventor: Yihua YOU, TAIZHOU (CN)

(21) Appl. No.: 17/036,171

(22) Filed: Sep. 29, 2020

Related U.S. Application Data
(63) Continuation of application No. PCT/CN2019/081390, filed on Apr. 4, 2019.

(30) Foreign Application Priority Data
Apr. 7, 2019 (CN) 201810303101.4

(51) Int. Cl. F16B 33/02

(52) U.S. Cl. CPC F16B 33/02

(57) ABSTRACT

A connect structure of a traditional thread and an bi-directional tapered internal thread having a lager left-end conical degree, the internal thread 6 forming a helical shape on the inner surface of a cylindrical body 2, and the complete threaded body unit forming a bidirectional tapered hole 41 in a dumbbell shape 94 having a small middle part and two large ends, the left-end conical degree 95 being greater than the right-end conical degree 96. The internal thread has the capability of fitting a traditional external thread 9, and the fitted external thread 9 on the outer surface of a columnar body 3 outlines a helical special tapered body 7, solving the problems of poor self-positioning and self-locking of existing threads, etc.

### CROSS-REFERENCE TO RELATED APPLICATIONS

This application is a continuation of International Patent Application No. PCT/CN2019/081390, filed on Apr. 4, 2019, entitled “CONNECT STRUCTURE OF A TRADITIONAL THREAD AND AN INTERNAL THREAD OUTLINING A BIDRECTIONAL TAPERED DUMBBELL SHAPE HAVING A LAGER LEFT-END CONICAL DEGREE,” which claims priority to China Patent Application No. 201810303101.4, filed on Apr. 7, 2018. The content of these identified applications are hereby incorporated by references.

### TECHNICAL FIELD

The invention belongs to the technical field of general technology of devices, and in particular relates to a bi-directional tapered dumbbell shape having a lager left-end conical degree, that is, a connect structure of a traditional thread and a dumbbell-like (the left-end conical degree being greater than the right-end conical degree) asymmetric bi-directional tapered internal thread (Hereinafter referred to as a traditional thread and an bi-directional tapered internal thread).

### BACKGROUND

The invention of the thread has a profound impact on the progress of human society. Thread is one of the most basic industrial technologies. It is not a specific product, but a key common technology in the industry. Its technical properties must be embodied by a specific product as an application carrier, which is widely used in various industries. The existing thread technology has a high level of standardization, mature technical theory, and long-term practical application. When used for fastening, it is a fastening thread; when it is used for sealing, it is a sealing thread; when it is used for transmission, it is a transmission thread. According to the national standard screw threads-vocabulary: “thread” refers to a dental body on the surface of a cylinder or cone that has the same tooth form and continuously bulges along a helix; “dental body” refers to the material entity between adjacent flanks. This is also the threaded definition of the global consensus.

The modern thread began in 1841 with the British Wyeth thread. According to modern thread technology theory, the basic condition for thread self-locking: the equivalent lrrietion angle should not be less than the helix angle. This is an understanding of modern thread technology based on its technical principle-“inclined surface principle”, which has become an important theoretical basis for modern thread technology. The first theoretical explanation of the principle of the inclined surface principle was Steven. He researched and discovered the conditions for the balance of objects on the inclined plane and the parallelogram law of composition of forces. In 1586, he proposed the famous inclined surface principle: what happens to an object placed on the inclined plane. The gravity along the inclined plane is proportional to the sine of the inclination angle. The inclined plane refers to a smooth plane inclined to the horizontal plane. The spiral is a deformation of the “inclined plane”. The thread is like an inclined plane wrapped around a cylinder. The smoother the inclined plane, the greater the mechanical benefit (see FIG. 7) (Yang Jingshan, Wang Xiuya, “Discussion on the Principle of Screws”, “Research on Gaussian Arithmetic”).

The “inclined surface principle” of modern threads is a sloped slider model based on the inclined surface law (see FIG. 8). It is believed that when the lead angle is less than or equal to the equivalent lrrietion angle under the condition of little change in static load and temperature, the thread pair has self-locking conditions. The thread lift angle (see FIG. 9) is the angle between the tangent of the helix on the pitch diameter cylinder and the plane perpendicular to the axis of thread. This angle affects the self-locking and looseness-proof of the thread. Equivalent lrrietion angle is the angle of friction when different friction forms are finally transformed into the most common inclined slider form. In layman's terms, in the inclined slider model, when the inclined plane is inclined to a certain angle, the friction force of the slider at this time is exactly equal to the component of gravity along the inclined plane. At this time, the object is just in the equilibrium state of force, and the inclined plane inclination angle at this time is called the equivalent irrietion angle.

American engineers invented the wedge thread in the middle of the last century, and its technical principle still follows the “inclined surface principle”. The invention of the wedge thread was inspired by the “wood wedge”. Specifically, The structure of the wedge-shaped thread is that there is a wedge-shaped Inclined plane at the root of the triangle form screw internal thread that forms an angle of 25° ˜30°with the axis of thread. The actual engineering is 30° Wedge-shaped slope. For a long time, people have researched and solved thread looseness-proof problems from the technical level and technical direction of thread angle, wedge thread technology is no exception, it is the specific application of oblique wedge technology.

However, the existing threads have problems such as low joint strength, weak self-positioning ability, poor self-locking, low load-bearing value, poor stability, poor compatibility, poor reusability, high temperature and low temperature, etc. Typically, bolts or nuts using modern thread technology generally have defects that are easy to loosen. With frequent vibration or vibration of equipment, cause bolts and nuts to loosen or even fall off, and serious safety accidents are prone to occur.

### SUMMARY

Any technical theory has theoretical hypothesis background, and thread is no exception. With technological progress, the damage to the connection is no longer pure linear load, more non-static, and non-room temperature environment, there is a linear load, a nonlinear load or even a superposition of the two, resulting in more complicated failure load situations, and application conditions complex, based on this recognition, the purpose of the present invention is to address the above-mentioned problems, a connection structure of a traditional thread and an bi-directional tapered internal thread with reasonable design, simple structure, good connection performance and locking performance is provided.

In order to achieve the above objective, the present invention adopts the following technical scheme: The connection structure of the traditional thread and the internal thread outlining a bi-directional tapered dumbbell shape is a threaded connect sets composed of an asymmetric an bi-directional tapered internal thread and a traditional external thread. It is a special thread pair technology that combines the technical characteristics of cone pair and spiral movement. The an bi-directional tapered internal thread is a thread technology that combines the technical features of the bidirectional cone and the spiral structure. The bidirectional cone is composed of two single cones, it is composed of two single cones in the direction of the left and right tapers facing each other and the taper of the left taper is greater than the taper of the right taper. The above-mentioned asymmetric bi-directional tapered internal thread is formed by a bidirectional conical body spirally distributed on the inner surface of a cylindrical mother body. The complete unit thread is a dumbbell-like special bidirectional cone geometry with a small middle and large ends and a left taper greater than the right taper.

The traditional thread and the bi-directional tapered internal thread, the dumbbell-like asymmetric bidirectional tapered internal thread definition can be expressed as: “On a cylindrical or conical surface, it has a asymmetrical bidirectional taper hole with prescribed left taper and a right taper, a left taper is opposite to the direction of the right taper and the left taper is greater than the right taper. A special bi-conical geometrical body with a dumbbell-like shape and a spiral shape that is continuously and/or discontinuously distributed along the spiral line and has a small middle and large ends.” Due to manufacturing reasons, the head and tail of an asymmetric bidirectional tapered thread may be incomplete bidirectional tapered geometry. Different from the modern thread technology, the thread technology has changed from the original modern thread internal thread and external thread engagement relationship to the bidirectional tapered thread internal thread and external thread amplexus relationship.

The bi-directional tapered internal thread and the traditional thread include external thread and internal thread that are matched with each other, bidirectional tapered holes with internal threads spirally distributed on the inner surface of the cylindrical mother body and a special cone with external threads spirally distributed on the outer surface of the columnar body, that is, the internal thread is in the form of a spiral bidirectional tapered hole and exists in the form of “incorporeal space”, and the external thread is in the form of a special spiral cone and is in the form of “material entity”. The incorporeal space refers to the space environment that can accommodate the above-mentioned material entities. The internal thread is the external member, and the external thread is the internal member: The internal thread and the external thread are screwed and sleeved together and amplexus together until one side is bidirectional bearing or the left and right sides are bidirectional bearing at the same time or until the sizing interference fit. Whether the two sides are bidirectional bearing at the same time is related to the actual working conditions of the application, that is, the bidirectional tapered hole of the bi-directional tapered internal thread contains a special tapered body section by section due to the special cone formed by contact with the bi-directional tapered internal thread, that is, the internal thread is the amplexus and corresponding external thread section by section.

The threaded connect sets is composed of a spiral outer cone surface and a spiral inner cone surface to form a cone pair to form a thread pair, and the inner cone surface of the thread outlining a bidirectional tapered dumbbell shape is a bidirectional cone surface. When the bi-directional tapered internal thread and the traditional thread form a threaded connect sets, the joint surface of inner cone surface of the thread outlining a bidirectional tapered dumbbell shape and the traditional external thread special conical surface is used as the supporting surface, that is, the conical surface is used as the supporting surface. The realization of connection technical performance, self-locking, self-positioning, reusability and fatigue resistance of the thread pair mainly depends on the size of the conical surface and taper of the internal thread forming the connection structure of the bi-directional tapered internal thread and the traditional thread. The external thread of the traditional thread is due to the special external conical surface and taper formed by contact with the bi-directional tapered internal thread. It is not a tooth form thread.

Different from the one-way force distributed on the inclined plane and the engagement relationship between the internal dental body and the external dental body of the internal and external threads shown by the principle of the existing thread inclined surface principle, the bi-directional tapered internal thread and the traditional thread, the internal thread body is bidirectional tapered body. No matter whether the internal thread body is distributed on the left or right side, the single cone cross-section through the cone axis is composed of two plain wire of the cone, that is, it is in a bidirectional state. The plain wire is the intersection of the cone surface and the plane passing through the cone axis. The conical principle of the connection structure of the internal thread outlining a tapered dumbbell shape and the traditional thread shows the axial force and the anti-axial force, both of which are synthesized by the bidirectional force, the axial force and the corresponding anti-axial force are aligned. The internal thread and the external thread are in an amplexus relationship, that is, the thread pair is composed of the internal thread to amplexus the external thread, that is, the section cone hole (inner cone) encapsulates the corresponding section cone (outer cone) until it is amplexus sizing fit to realize self-positioning or until the sizing interference contact realizes self-locking, that is, the inner cone and the outer cone can be self-locked or self-positioned by the tapered hole and the special cone radially encapsulated together to realize the thread pair self-locking or self-positioning. It is not like the traditional threaded internal thread and external thread to form a threaded connection pair, which realizes the threaded connection performance by mutual dental body and dental body abutment.

There will be a self-locking force when the internal thread and the external thread meet certain conditions. The self-locking force is generated by the pressure generated between the inner cone axial force and the outer cone anti-axial force, that is, when the inner cone and the outer cone composes a cone pair, the inner cone surface of the inner cone amplexus the outer cone surface of the outer cone, and the inner cone surface is in close contact with the outer cone surface. The inner cone axial force and the outer cone anti-axial force are the unique force concept of the thread outlining a bidirectional tapered dumbbell shape technology of the present invention, that is, the cone pair technology.

The inner cone exists in a form similar to a shaft sleeve. Under the action of external load, the inner cone generates an axial force pointing or pressing against the cone axis. The said axial force is a bidirectional synthesis of a pair of centripetal forces centered on the cone axis, which are mirrored and perpendicular to the two plain wire of the cone, that is, the axial force passing through the cone axis section is composed of two centripetal forces that are mirrored and bidirectionally distributed on both sides of the cone axis with the cone axis as the center and are respectively perpendicular to the two plain wire of the cone and point or press against the common point of the cone axis. And when the above-mentioned cone and helical structure are combined into a thread and applied to the thread pair, and the axial force passing through the thread axis section is composed of two centripetal forces that are mirrored and bidirectionally distributed on both sides of the thread axis with the thread axis as the center and are respectively perpendicular to the two plain wire of the cone and point or press against the common point of the thread axis. The axial force is densely distributed on the cone axis and/or thread axis in an axial and circumferential manner.

The axial force corresponds to an axial force angle, the angle between the two centripetal forces composing the axial force constitutes the above-mentioned axial force angle. The said axial force angle depends on the taper of the cone, that is, the taper angle.

Axial force and anti-axial force begin to be generated when the inner and outer cones of the cone pair are in effective contact, that is, the effective contact process between the inner cone and the outer cone of the cone pair always has a pair of pairs of corresponding and opposite axial force and anti-axis. The stated axial force and anti-axial force are both bidirectional forces centered on the conical axis and/or thread axis and distributed in a mirror image direction instead of one-way power. The cone axis and the thread axis are coincident axis, that is, the same axis and/or approximately the same axis, the anti-axial force and the axial force are oppositely collinear, and when the above-mentioned cone and helical structure are combined into threads and form a thread pair, they are oppositely collinear and/or similar oppositely collinear, amplexus through the inner cone and the outer cone until the interference, the axial force and the anti-axial force will generate the pressure at the contact surface of the inner and outer cone, and densely distributed axially and circumferentially evenly on the contact surface of the inner and outer cone surfaces. When the amplexus motion of the inner cone and the outer cone continues until the cone pair reaches the interference fit, the generated pressure combines the inner cone with the outer cone, that is, the above-mentioned pressure can reach the inner cone amplexus the outer cone to form a similar integral structure, and after the external force it promotes disappears, it will not cause the inner and outer cones to separate from each other under the action of gravity due to the arbitrary change of the position of the similar integral structure, and the cone pair will be self-locking, that is, the thread pair produces self-locking. This self-locking property also has a certain limit of resistance to other external loads that may cause the inner and outer cones to separate from each other besides gravity. The cone pair also has the self-positioning ability of the inner cone and the outer cone to cooperate with each other, but not any axial force angle and/or anti-axial force angle can make the cone pair self-locking and self-positioning.

When the axial force angle and/or anti-axial force angle is less than 180° and greater than 127°, the cone pair is self-locking. And the axial force angle and/or anti-axial force angle is infinitely close to 180°, the self-locking of the cone pair is the best, and its axial load capacity is the weakest. The axial force angle and/or anti-axial force angle is equal to and/or less than 127° and greater than 0°, then the cone pair is in weak self-locking and/or not in the self-locking interval, the axial force angle and/or the anti-axial force angle tend to change infinitely close to 0°, then the self-locking of the cone pair will change in the direction of attenuation until it has no self-locking ability at all. The load-bearing capacity shows an increasing trend and changes direction until the axial load-bearing capacity is the strongest.

When the axial force angle and/or anti-axial force angle is less than 180° and greater than 127°, the cone pair is in a strong self-positioning state, and it is easy to achieve strong self-positioning. When the axial force angle and/or anti-axial force angle is infinitely close to 180°, the inner and outer cones of the cone pair have the strongest self-positioning ability. When the axial force angle and/or the anti-axial force angle is equal to or less than 127° and greater than 0°, and the cone pair is in a weak self-positioning state. When the axial force angle and/or the anti-axial force angle tend to change infinitely close to 0°, and the mutual self-positioning ability of the inner and outer cones of the cone pair will change in the direction of attenuation until it is nearly completely without self-positioning ability.

Compared with the unidirectional tapered thread of the single cone invented by the applicant before, unidirectional tapered thread of the single cone invented can only be loaded on one side of the conical surface, irreversible, and the relationship between unilateral and bidirectional inclusion. The reversibility of the bidirectional tapered thread with bidirectional taper is that the left and right sides of the tapered thread can be contained in both directions, It can carry on the left side of the cone surface and/or the right side of the cone surface and/or the left side cone surface and the right side cone surface respectively and/or the left side cone surface and the right side cone surface carry both directions simultaneously. More restrict the disordered degree of freedom between the tapered hole and the special outer cone, spiral movement allows the traditional thread and the bi-directional tapered internal thread connection structure to obtain the necessary orderly degree of freedom, effectively synthesize the technical characteristics of cone pair and thread pair to form a new thread technology.

When the connection structure of the traditional thread and the bi-directional tapered internal thread is used, the special cone surface of the traditional external thread and the bidirectional tapered hole conical surface of the thread outlining a bidirectional tapered dumbbell shape are matched with each other.

The traditional thread and the bi-directional tapered internal thread, the bidirectional tapered internal thread, that is, the tapered hole does not have any taper or any taper angle can realize the self-locking and/or self-positioning of the threaded connect sets, and the inner cone must reach a certain taper, in other words, with a certain taper angle, the traditional thread and the bi-directional tapered internal thread connection structure have self-locking and self-positioning properties. The taper includes the left taper and the right taper of the internal thread body, the taper angle includes the left taper angle and the right taper angle of the internal threaded body. The left taper corresponds to the left taper angle, that is, the first taper angle α 1. Preferably, 0°<first taper angle α 1<53°, preferably, A cone angle α 1 takes a value of 2°-40°. For some special fields, preferably, the 53°<first cone angle α 1<180°, and preferably, the first cone angle α1 takes a value of 53°˜90.°; The right taper corresponds to the right taper angle, that is, the second taper angle β2, preferably 0°<the second taper angle α2<53°, preferably, the second taper angle α2 takes a value of 2°-40°.

The above-mentioned individual special fields refer to threaded connection application field with low self-locking requirements or even no need for self-locking and/or weak self-positioning requirements and/or high axial bearing capacity requirements and/or anti-locking measures must be provided, etc. Threaded connection application field.

The traditional thread and the bi-directional tapered internal thread. The internal thread is arranged on the inner surface of the cylindrical mother body. The characteristic is that the cylindrical mother body has a nut body, and the inner surface of the nut has spirally distributed the tapered hole, the tapered hole includes a bidirectional tapered hole, the cylindrical mother body includes a cylindrical body and/or a non-cylindrical body and other workpieces and objects that need to be processed with internal threads on its inner surface. The inner surface includes the inner surface geometry such as cylindrical surface and non-cylindrical surface such as conical surface.

The traditional thread and the bi-directional tapered internal thread. The bidirectional tapered hole is the internal thread, which is characterized by is made up of two tapered holes with the same bottom surface and the same top surface but different cone heights. The top surface is symmetrical and mutually joined in a spiral shape to form a thread. The bottom surface is at the two ends of the two-way tapered hole and forms a dumbbell-shaped asymmetrical bidirectional tapered threads, including the mutual engagement respectively with the lower bottom surfaces of the adjacent bidirectional tapered holes and/or the mutual engagement respectively with the lower bottom surfaces of the adjacent bidirectional tapered holes to form a screw thread. The internal thread includes a first helical conical surface of the tapered hole and a second helical conical surface of the tapered hole and an inner spiral, in the section passing through the thread axis, its complete single-section asymmetrical bidirectional tapered internal thread is a dumbbell-like special bidirectional tapered geometry with a small middle and large ends and a left taper greater than the right taper. The bidirectional tapered hole includes a bidirectional tapered hole conical surface, the left side of the conical surface is the first spiral conical surface of the tapered hole, the angle formed by two plain wire is the first cone angle α1, the first spiral conical surface of the tapered hole forms a left taper and is distributed to the right. The right conical surface is the second spiral cone surface of the tapered hole. The angle formed by the two plain wire is the second cone angle α2, the second spiral conical surface of the tapered hole forms a right taper and is distributed to the left. The first taper angle α1 and the second taper angle α2 correspond to the taper directions. The plain wire is the intersection of the cone surface and the plane passing through the cone axis. The shape formed by the first helical conical surface of the tapered hole and the second helical conical surface of the tapered hole of the bidirectional tapered hole is the same as that of the lower base and the upper base that coincide with the central axis of the cylindrical mother body. The upper bases of the two right-angled trapezoids with different right-angle sides are symmetrical and oppositely joined. The shape of the spiral outer surface of the spiral body formed by the two oblique sides of the right-angle trapezoidal combination is the same. The right-angled trapezoidal combined body refers to the upper bottom of two right-angled trapezoids with the same lower base and the same upper base but different right angle sides. A special geometric body with symmetrical sides and joints facing each other, and the bottom sides are respectively at the two ends of the right-angled trapezoidal combined body.

The bi-directional tapered internal thread has the unique technical characteristics and advantages of its threaded body being a tapered body, namely a tapered hole, that is, It has the ability to assimilate the traditional thread with it into a special form of tapered thread with the same technical characteristics and properties as its own. The traditional thread assimilated by the tapered thread, that is, the alienated traditional thread. It seems that the shape of the thread body is not much different from the traditional thread dental body, but it no longer has the substantive technical content of the thread body of the traditional thread. The threaded body has changed from the original traditional threaded dental body nature to the special tapered geometry with the tapered thread nature and technical characteristics. The special cone geometry has a special cone surface that can match the helical cone surface of the tapered thread in the radial direction. The above-mentioned traditional threads include triangular threads, trapezoidal threads, sawtooth threads, rectangular threads, arc threads, etc., which can be screwed with the above bidirectional tapered threads to form other geometric forms of the threaded connect set, but not limited to the above.

When the traditional thread and the internal thread outlining a bi-directional tapered dumbbell shape cooperate to form a threaded connect sets, the traditional external thread at this time is not a traditional thread in the original sense, but a special form of tapered thread that is assimilated by the tapered thread. Its contact part with the internal thread outlining a bi-directional tapered dumbbell shape forms the outer surface of the special tapered body of the traditional external thread of the threaded connect sets that can match the helical conical surface of the tapered thread, that is, the special tapered body has a special tapered surface. With the increase in the number of screwing and use, the effective conical surface area of the special conical surface on the special cone of the traditional external thread will continue to increase, that is, the special conical surface will continue to increase and tend to be better than the conical surface of the a internal thread outlining a bi-directional tapered dumbbell shape conical hole. The change in the direction of the large contact surface essentially forms a special cone that has the technical spirit of the present invention even though the geometric shape of the cone is incomplete. Furthermore, a special tapered body is a threaded body that is assimilated by the traditional external thread due to its cohesive contact with the bidirectional tapered internal thread, and is a special tapered geometry transformed from the traditional external threaded thread. The above-mentioned special tapered body radially has an outer surface that can match the conical surface of the bidirectional tapered hole. The threaded connect sets is a special tapered body formed by a spiral-shaped special outer cone surface, that is, The special cone formed by the traditional external thread contacting the bi-directional tapered internal thread. The special cone surface and the helical inner cone surface, that is, the inner cone surface of the bi-directional tapered internal thread, cooperate to form a cone pair to form a thread pair. The inner conical surface is the inner conical surface of the inner cone, that is, the spiral conical surface of the bi-directional tapered internal thread taper hole is a bidirectional conical surface. The traditional thread assimilated by it is an alienated traditional thread, a special form of tapered thread. This special form of tapered thread outer conical surface, that is, the special conical surface of traditional external thread, first appears in the form of a line. And with the increase in the number of times of contact and use between the traditional external thread cusp and the bi-directional tapered internal thread tapered hole, the external cone gradually increases, that is, the special conical surface of the traditional external thread is constantly changing and increasing from the microscopic surface (the Macro is the line) to the macroscopic surface. It is also able to directly machine the outer cone surface that matches the bi-directional tapered internal thread on the cusp of the traditional external thread. These are in line with the technical spirit of the present invention.

The traditional thread and the bi-directional tapered internal thread. The external thread is arranged on the outer surface of the cylindrical mother body. The characteristic is that the cylindrical mother body has a screw body, and the outer surface of the screw has special cones distributed in a spiral shape. The special tapered body refers to the special tapered body formed by the traditional external thread in contact with the bi-directional tapered internal thread. The special cone body has a special cone surface. The cylindrical mother body can be solid or hollow, including cylindrical and/or non-cylindrical workpieces and objects that need to be threaded on their outer surface. The outer surface includes outer surface geometry like non-cylindrical surfaces such as cylindrical surfaces and conical surfaces, etc.

When the connection structure of the traditional thread and the bi-directional tapered internal thread works, the relationship with the workpiece includes rigid connection and non-rigid connection. The rigid connection means that the nut supporting surface and the workpiece supporting surface are mutually supporting surfaces, including structural forms such as single nut and double nut, and the non-rigid connection means that the opposite side end surfaces of the two nuts are mutually supporting surfaces and/or there is a gasket between the opposite side faces of two nuts, which are indirectly supporting each other. It is mainly used in non-rigid materials or non-rigid connection workpieces such as transmission parts or application fields such as double-nut installation to meet requirements. The workpiece refers to the connected object including the workpiece, and the gasket refers to the spacer including the gasket.

When the traditional thread and the bi-directional tapered internal thread adopt the connection structure of the traditional threaded bolt and the bidirectional tapered thread and double nut, and the relationship with the workpiece is rigidly connected, the tapered thread bearing surface is different. When the cylindrical matrix is on the left side of the fastened workpiece, that is, the left end face of the workpiece to be tightened, and the cylindrical mother body, that is, the right end face of the left nut body is the locking bearing surface of the left nut body and the tightened workpiece, The left side helical conical surface of the bidirectional taper thread of the left nut body is the taper thread bearing surface, that is, the first helical conical surface of the bidirectional tapered inner threaded taper hole and the special conical surface of the traditional external thread are the tapered thread bearing surface and the first spiral conical surface of the tapered hole and the special conical surface of the traditional external thread are mutually supporting surfaces. When the cylindrical mother body is located on the right side of the workpiece to be fastened, that is, the right end surface of the workpiece to be fastened, and the cylindrical mother body is the left side of the right nut body. When the cylindrical mother body, that is, the left end surface of the right nut body is, the locking bearing surface of the right nut body and the workpiece to be tightened, the right side helical conical surface of the bidirectional taper thread of the right nut body is the taper thread bearing surface, that is, the second helical conical surface of the bidirectional tapered internally threaded conical hole and the special conical surface of the traditional external thread are the bearing surfaces of the tapered thread, and the second helical conical surface of the conical hole and the special conical surface of the traditional external thread are mutually supporting surfaces.

When the bidirectional tapered internal thread and the traditional thread adopt the connection structure of the traditional threaded bolt and the bidirectional tapered thread single nut, and the relationship with the fastened workpiece is rigidly connected, when the hexagon head of the bolt is on the left side, The cylindrical mother body, namely the nut body, that is, the single nut is located on the right side of the fastened workpiece. When the bolt and single nut connection structure works, the right end surface of the workpiece and the left end surface of the nut body are the locking bearing surfaces of the nut body and the fastened workpiece. The right side helical conical surface of the bidirectional tapered thread of the nut body is the tapered thread bearing surface, that is, the second helical conical surface of the bidirectional tapered inner threaded taper hole and the special conical surface of the traditional external thread are the tapered thread bearing surface and the second spiral conical surface of the tapered hole and the special conical surface of the traditional external thread are mutually supporting surfaces; when the hexagon head of the bolt is located on the right side, the cylindrical mother body, namely the nut body, that is, the single nut is located on the left side of the workpiece to be fastened. When the bolt and single nut connection structure is working, the left end surface of the workpiece and the right end surface of the nut body are the locking bearing surfaces of the nut body and the workpiece to be fastened, and the left side helical conical surface of the bidirectional taper thread of the nut body it is a tapered thread bearing surface, that is, the first helical conical surface of the bidirectional tapered inner threaded conical hole and the first spiral conical surface of the tapered hole and the special conical surface of the traditional external thread are mutually supporting surfaces.

When the bidirectional tapered internal thread and the traditional thread adopt the connection structure of the traditional threaded bolt and the bidirectional tapered thread single nut, and the relationship with the fastened workpiece is non-rigid connected, the tapered thread bearing surface is different. The cylindrical mother body includes the left nut body and the right nut body, the right end surface of the left nut body and the left end surface of the right nut body are in direct contact with each other and are the locking support surface, when the right end surface of the left nut body is the locking support surface, the left side helical conical surface of the bidirectional taper thread of the left nut body is the taper thread bearing surface, that is, the first helical conical surface of the bidirectional taper internally threaded taper hole and the special conical surface of the traditional external thread are taper threads supporting surface, and the first spiral conical surface of the tapered hole and the special conical surface of the traditional external thread are mutually supporting surfaces. When the left end surface of the right nut body is the locking bearing surface, the right side helical conical surface of the bidirectional tapered thread of the right nut body is the tapered thread bearing surface, that is, the second helical conical surface of the bidirectional tapered inner threaded conical hole and the special conical surface of the traditional external thread are the tapered thread bearing surface and the second helical conical surface of the tapered hole and the special conical surface of the traditional external thread is mutually supporting surface.

When the bidirectional tapered internal thread and the traditional thread adopt the connection structure of the traditional threaded bolt and the bidirectional tapered thread single nut, and the relationship with the fastened workpiece is non-rigid connected, the tapered thread bearing surface is different. The cylindrical mother body includes the left nut body and the right nut body and the two cylindrical mother bodies, that is, there are spacers such as gasket between the left nut body and the right nut body, the right end face of the left nut body and the left end face of the right nut body indirect contact with each other through the gasket, thus indirectly acting as a locking bearing surface. When the cylindrical mother body is on the left side of the gasket, the right end surface of the left nut body is the locking bearing surface of the left nut body. The left side helical conical surface of the bidirectional taper thread of the left nut body is the taper thread bearing surface, that is, the first helical conical surface of the bidirectional taper internally threaded taper hole and the special conical surface of the traditional external thread are the tapered thread bearing surface. The first spiral conical surface of the tapered hole and the special conical surface of the traditional external thread are mutually supporting surfaces. When the cylindrical mother body is located on the right side of the gasket, and the left end surface of the right nut body is the locking bearing surface of the right nut body, the right helical conical surface of the bidirectional taper thread of the right nut body is the tapered thread bearing surface, that is, the second helical conical surface of the bi-directional taper internal thread taper hole and the special conical surface of the traditional external thread is a tapered thread supporting surface, and the second helical conical surface of the tapered hole and the special conical surface of the traditional external thread are mutually supporting surface.

Furthermore, when the above-mentioned cylindrical mother body on the inner side, that is, the nut body adjacent to the fastened workpiece has been effectively combined with the cylindrical mother body, that is, the internal thread and external thread forming the threaded connect sets are effectively held together. The cylindrical mother body located on the outside, that is, the nut body that is not adjacent to the fastened workpiece, can be kept in its original shape and/or removed according to the application conditions, leaving only one nut (for example, the weight of the equipment is required or the double nuts are not required to ensure the reliability of the connection technology and other application fields), the removed nut body is not used as a connecting nut but only used as an installation process nut. The internal thread of the described installation process nut is not only made of bi-directional tapered threads, but also made of one-way tapered threads and other threads that can be screwed with bolt threads, including nut bodies made of traditional threads like triangular threads, trapezoidal threads, and sawtooth threads but it is not limited to the above, and can be used if applicable. To ensure the reliability of the connection technology, the threaded connect set is a closed-loop fastening technology system, that is, the internal thread and the external thread of the threaded connect set are effectively amplexus together. The threaded connect set will become an independent technical system without relying on the third party technical compensation to ensure the technical effectiveness of the connection technology system, that is, even if there is no support from other objects, including the gap between the threaded connect set and the workpiece to be fastened, it will not affect the effectiveness of the threaded connection, which will help greatly reduce the weight of the equipment, remove the dead load, and improve the effective load capacity, braking performance, energy saving and so on. This is the unique thread technology advantage when the connection structure between the bidirectional tapered internal thread and the traditional thread and the workpiece to be fastened is a non-rigid connection or a rigid connection.

When the bidirectional tapered internal thread and the traditional thread is connected with the transmission, Through the screw connection and the bidirectional load of the bidirectional tapered hole and the traditional external thread special cone. When the external thread and the internal thread form a thread pair, there must be clearance between the bidirectional tapered hole and the special cone of the traditional external thread. If there is oil and other media lubrication between the internal thread and the external thread, it will easily form a bearing oil film. The clearance is conducive to the formation of the bearing oil film. Thread connect set is equivalent to a group of sliding bearing pairs composed of one pair and/or several pairs of sliding bearings, that is, each section of bidirectional tapered internal thread bidirectionally contains a section of traditional external thread to form a pair of sliding bearings, the number of sliding bearings composed is adjusted according to the application conditions, that is, the effective bidirectional engagement of the bidirectional tapered internal thread and the traditional external thread, that is, the number of contained and contained thread sections for effective bidirectional contact engagement, designed according to the application conditions, contain the special cone of traditional external thread through the tapered internally threaded tapered hole and position in the radial, axial, angular and circumferential directions, etc. Preferably, through the bidirectional tapered hole, the special cone is contained, and the radial and circumferential main positioning is supplemented by the axial and angular auxiliary positioning to form the multi-directional positioning of the inner and outer cones until the conical surface of the bidirectional tapered hole and the special conical surface of the special cone are engaged to achieve self-positioning or until the sizing interference contact produces self-locking. It constitutes a special composite technology of cone pair and thread pair to ensure the accuracy, efficiency and reliability of the tapered thread technology, especially the bidirectional tapered internal thread and the traditional thread transmission.

When the bidirectional tapered internal thread is fastened and sealed with the traditional thread, its technical performance is realized by the screw connection of the tapered internal threaded bidirectional tapered hole and the traditional external thread special cone, that is, it is achieved by the first helical conical surface of the tapered hole and the special conical surface of the traditional external thread special cone are sized until the interference and/or the second helical cone surface of the tapered hole and the special cone surface of the traditional external thread special cone are sizing until the interference. According to the application conditions, load in one direction and/or load in two directions simultaneously, that is, the bidirectional tapered hole is guided by the spiral line, the inner cone and the traditional external thread special outer cone inner and outer diameter are centered until the first helical cone surface of the tapered hole is entangled with the special cone surface of the traditional external thread special cone until the interference contact and/or the second helical conical surface of the tapered hole and the special conical surface of the traditional external thread special cone are held until interference contact, that is, through the Self-locking of the tapered internal thread bidirectional internal cone containing the special cone of traditional external thread and positioning in multiple directions such as radial, axial, angular, and circumferential. Preferably, through the bidirectional tapered hole, the special cone is contained, and the radial and circumferential main positioning is supplemented by the axial and angular auxiliary positioning to form the multi-directional positioning of the inner and outer cones until the conical surface of the bidirectional tapered hole and the special conical surface of the special cone are engaged to achieve self-positioning or until the sizing interference contact produces self-locking. It constitutes a special composite technology of cone pair and thread pair to ensure the accuracy, efficiency and reliability of the tapered thread technology, so as to realize the technical performance of mechanical mechanism connection, locking, anti-loosening, bearing, fatigue and sealing and so on.

Therefore, this bidirectional tapered internal thread and the traditional thread connection structure mechanical mechanism transmission accuracy, efficiency, bearing capacity, self-locking locking force, anti-loosening capacity, sealing performance and other technical performance are related to the size of the first helical conical surface of the tapered hole and the left taper formed by it is the size of the corresponding first cone angle α1, and the size of the second helical conical surface of the tapered hole and the right taper formed by it is its corresponding second Cone angle α2. It is also related to the special external taper surface of special cone of the traditional external thread formed by contacting the internal thread of the bidirectional tapered thread and its taper. The material friction coefficient, processing quality and application conditions of the columnar body and the cylindrical matrix also have a certain influence on the cone fit.

In the above-mentioned bidirectional tapered internal thread and the traditional thread, when the right-angled trapezoidal combined body makes one revolution at a constant speed, the axial movement distance of the right-angled trapezoidal combined body is that at least one time the length of the sum of the right-angled sides of two right-angled trapezoids with the same bottom base and the same upper base but different right-angled sides. This structure ensures that the first helical conical surface of the tapered hole and the second helical conical surface of the tapered hole have sufficient length, thereby ensuring that the conical surface of the bi-directional tapered hole has sufficient effective contact area and strength and the efficiency required for spiral motion when matched with the special conical surface of the special cone of the traditional external thread.

In the above-mentioned bi-directional tapered internal thread and the traditional thread, then the right-angled trapezoidal combined body makes one revolution at a constant speed, the axial movement distance of the right-angled trapezoidal combined body is that at least one time the length of the sum of the right-angled sides of two right-angled trapezoids with the same bottom base and the same upper base but different right-angled sides. This structure ensures that the first helical conical surface of the tapered hole and the second helical conical surface of the tapered hole have sufficient length, thereby ensuring that the conical surface of the bi-directional tapered hole has sufficient effective contact area and strength and the efficiency required for spiral motion when matched with the special conical surface of the traditional external thread.

In the bi-directional tapered internal thread and the traditional thread, the first spiral conical surface of the tapered hole and the second spiral conical surface of the tapered hole are both continuous spiral surfaces or discontinuous spiral surfaces.

In the bidirectional tapered internal thread and the traditional thread, the special conical surface of the special cone body is a continuous spiral surface or a discontinuous spiral surface.

In the above-mentioned bi-directional tapered internal thread and traditional thread, one end and/or both ends of the columnar mother body can be screwed into the screw-in end of connecting hole of cylindrical mother body. The small diameter head of the bidirectional tapered external thread of the female screw body. The first helical conical surface of the tapered internal thread is in contact with the special conical surface of the traditional external thread and/or the interference fit and/or the second helical conical surface of the tapered internal thread is in contact with the special conical surface of the traditional external thread and/or interference fit realizes threaded connection function.

In the above-mentioned bi-directional tapered internal thread and traditional thread, one end of the columnar mother body is provided with a head with a size larger than the outer diameter of the columnar mother body and/or one end and/or both ends of the cylindrical parent body are provided with the head of small diameter of bidirectional tapered external thread smaller than columnar mother body screw body. And the connecting hole is a threaded hole provided on the nut, that is, the columnar mother body and the head are connected as bolts, and there is no head and/or the head at both ends is smaller than the small diameter of the bi-directional tapered external thread and/or there is no thread in the middle with two ends with bi-directional tapered external thread are stud. The connecting hole is arranged in the nut.

Compared with the existing technology, the advantages of the connection structure of the bi-directional tapered internal thread and the traditional thread pair are: reasonable design, simple structure, bi-directional load-bearing or straight sizing of the cone pair formed by the inner and outer cone coaxial inner and outer diameter centering up to interference fit to realize the fastening and connection functions, convenient operation, large locking force, large load-bearing value, good anti-loosening performance, high transmission efficiency and precision, good mechanical sealing effect, good stability, and can prevent occurrence of connection loose phenomenon, with self-locking and self-positioning functions.

### BRIEF DESCRIPTION OF THE DRAWINGS

FIG. 1 is a structural schematic diagram of a dumbbell-like shape (the taper on the left is greater than the taper on the right) asymmetric bidirectional tapered threaded internal thread and the traditional thread connection pair according to the first embodiment of the present invention.

FIG. 2 is a dumbbell-like (the taper on the left is greater than the taper on the right) asymmetric bidirectional tapered internal thread and its complete unit thread structure according to the first embodiment of the present invention.

FIG. 3 is a schematic diagram of the connection structure of a dumbbell-like (the taper on the left is greater than the taper on the right) asymmetric bidirectional tapered threaded double nut and a traditional threaded bolt according to the second embodiment of the present invention.

FIG. 4 is a schematic diagram of the connection structure of a dumbbell-like (the taper on the left side is greater than the taper on the right side) asymmetric bidirectional taper threaded single nut and a traditional threaded bolt according to the third embodiment of the present invention.

FIG. 5 is a schematic diagram of the connection structure of a dumbbell-like (the taper on the left side is greater than the taper on the right side) asymmetric bidirectional tapered threaded double nut and a traditional threaded bolt according to the fourth embodiment of the present invention.

FIG. 6 is a schematic diagram of the connection structure of a dumbbell-like (the taper on the left side is greater than the taper on the right side) asymmetric bidirectional tapered threaded double nut (with a gasket in the middle) and a traditional threaded bolt according to the fifth embodiment of the present invention.

FIG. 7 is an illustration of “the thread of the prior thread technology is an inclined plane on the surface of a cylinder or a cone” involved in the background art of the present invention.

FIG. 8 is an illustration of the “principle of existing thread technology-inclined plane sliding block model of inclined plane principle” involved in the background art of the present invention.

FIG. 9 is an illustration of “the lead angle of the prior thread technology” involved in the background art of the present invention. In the figure, the tapered thread 1, the cylindrical mother body 2, the nut body 21, the nut body 22, the columnar body 3, the screw body 31, the tapered hole 4, the bidirectional tapered hole 41, the bidirectional tapered hole cone surface 42, conical hole first spiral conical surface 421, first cone angle α1, tapered hole second helical cone surface 422, second cone angle α2, internal spiral line 5, internal thread 6, special cone 7, special cone 72, external thread 9, dumbbell-like 94, left taper 95, right taper 96, left distribution 97, right distribution 98, thread connect set and/or thread pair 10, clearance 101, locking bearing surface 111, locking support surface 112, tapered thread support surface 122, tapered thread support surface 121, workpiece 130, nut body locking direction 131, gasket 132, cone axis 01, thread axis 02, slider A on the inclined surface, Inclined body B, gravity G, gravity along the slope component G1, friction force F, lead angle φ, equivalent friction angle P, traditional external thread major diameter d, traditional external thread minor diameter d1, traditional external thread middle diameter d2.

### DETAILED DESCRIPTION OF EMBODIMENTS

The present invention will be further described in detail below with reference to the drawings and specific embodiments.

### Embodiment One

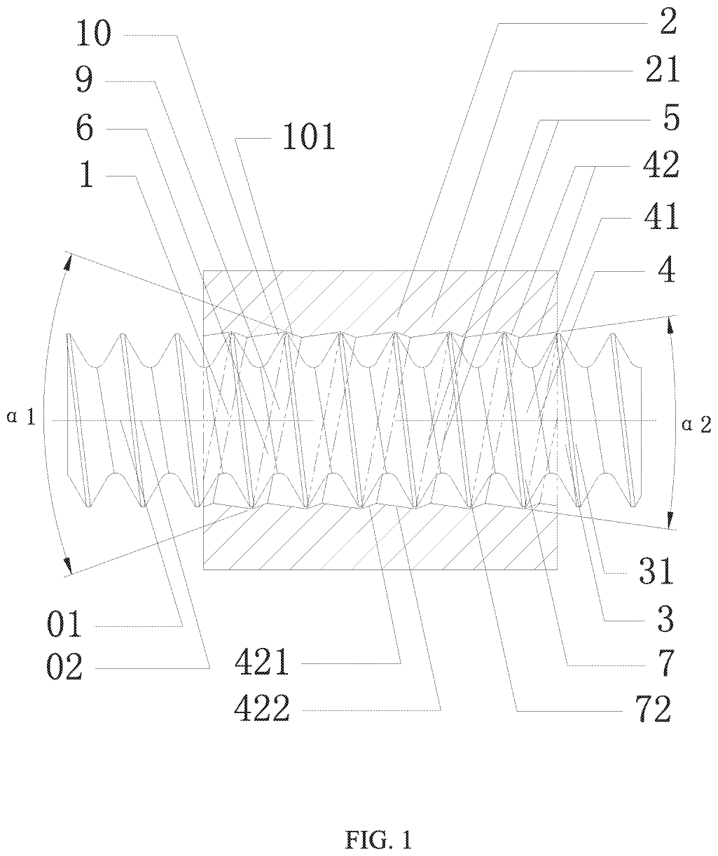

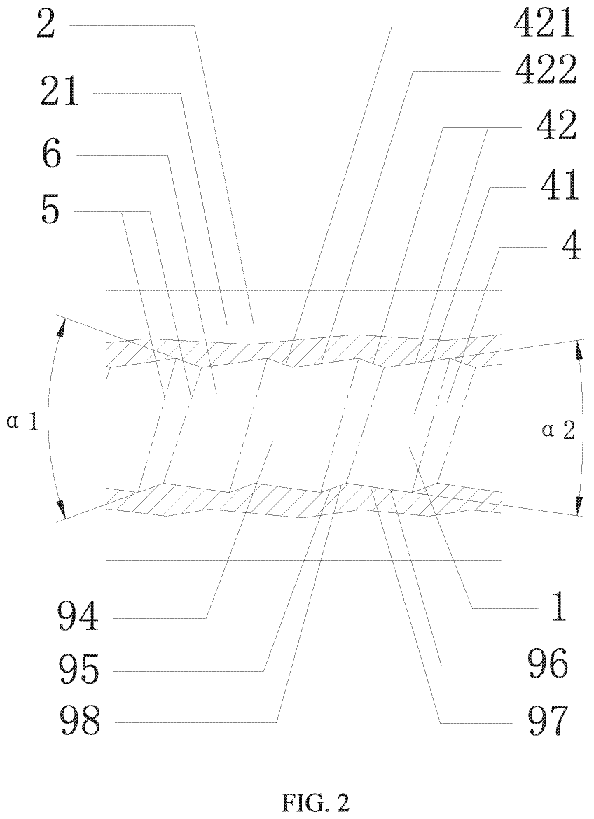

As shown in FIGS. 1 and 2, this embodiment adopts the connection structure of the asymmetric bidirectional tapered internal thread 6 and the traditional external thread 9. This bidirectional tapered internal thread and the traditional threaded connect set 10, include bidirectional tapered holes 41 distributed spirally on the inner surface of the cylindrical mother body 2 and the traditional threaded external thread 9 are due to the special tapered body 7 formed in contact with the bidirectional tapered threaded thread 6 and distributed on the outer surface of the cylindrical mother body 3, that is, include internal thread 6 and external thread 9 with mutual threading. The internal thread 6 is distributed with a spiral bidirectional tapered hole 41. The internal thread 6 exists in the form of a spiral bidirectional tapered hole 41 and a “non-solid space”. The thread 9 exists of a spiral special cone 7 and exists as a “material entity”. The internal thread 6 and the external thread 9 are the relationship between the containing part and the contained part: the internal thread 6 and the external thread 9 are screwed together one by one. Sleeve and hold together until the interference fit, that is, bidirectional tapered holes 41 contain traditional external threads 9 section by section due to special cone 7 formed by contact with bidirectional tapered internal thread 6. and the spiral motion allows the bidirectional tapered internal thread and the traditional thread connection pair 10 to obtain the necessary orderly degree of freedom, effectively synthesizing the cone pair and the thread pair Technical characteristics. The bidirectional containment limits the disordered freedom between the tapered hole 4 and the special cone 7 of the traditional external thread 9. Spiral movement allows the bidirectional tapered internal thread and the traditional thread connect set 10 to obtain the necessary orderly degree of freedom, effectively synthesize the technical characteristics of cone pair and thread pair.

In this embodiment, when the bidirectional tapered internal thread and the traditional threaded connect set 10 are in use, the bidirectional tapered hole conical surface 42 and the special conical body 72 of the traditional external thread 9 cooperate with each other.

The asymmetric bidirectional tapered internal thread in this embodiment and the tapered hole 4 of the traditional threaded connect set 10 reach a certain taper, that is, the cone reaches a certain taper angle, the threaded connect set 10 has self-locking and Self-positioning. The taper includes a left taper 95 and a right taper 96. The cone angle includes a left cone angle and a right cone angle. The left taper 95 corresponds to the left cone angle, that is, the first cone angle α1. Preferably, 0°<first taper angle α1<53°, preferably, A cone angle α1 takes a value of 2°-40°. For some special fields, preferably, the 53°<first cone angle α1<180°, and preferably, the first cone angle α1 takes a value of 53°˜90°; The right taper corresponds to the right taper angle, that is, the second taper angle α2, preferably 0°<the second taper angle α2<53°, preferably, the second taper angle α2 takes a value of 2°-40°.

The external thread 9 is arranged on the outer surface of the columnar mother body 3. It is, characterized in that the columnar mother body 3 has a screw body 31, and the outer surface of the screw body 31 is provided with a traditional external thread 9 which is refers to other geometrical threads including triangular threads, trapezoidal threads, sawtooth threads, etc., which can be screwed with the above-mentioned bidirectional tapered thread 1 to form the thread connect set 10. When the traditional external thread 9 and the bidirectional tapered internal thread 6 cooperate to form a threaded connect set 10, the traditional external thread 9 at this time is no longer a traditional thread in the original sense, but a special form of tapered thread 1, its contact part with the bidirectional tapered internal thread forms the special cone 7 of the traditional external thread 9 of the threaded connect set. The special cone 7 has a special conical surface 72, With the increase in the number of screwing and use, the effective conical surface area of the special conical surface on the special cone 72 of the traditional external thread 9 will continue to increase, that is, the special conical surface 72 will continue to increase and tend to be better than the conical surface 42 of the a internal thread outlining a bi-directional tapered dumbbell shape 6 conical hole. The change in the direction of the large contact surface essentially forms a special cone 7 that has the technical spirit of the present invention even though the geometric shape of the cone is incomplete. The special conical surface 72 of traditional external thread 9 first appears in the form of a line. And with the increase in the number of times of contact and use between the traditional external thread 9 cusp and the bi-directional tapered internal thread 6 tapered hole 4, the external cone gradually increases, that is, the special conical surface 72 of the traditional external thread 9 is constantly changing and increasing. It is also able to directly machine the outer cone surface that matches the bi-directional tapered internal thread 6 on the cusp of the traditional external thread. These are in line with the technical spirit of the present invention. The columnar mother body 3 can be solid or hollow, including cylindrical, cone, tube and other workpieces and objects that need to be processed with external threads on its outer surface.

The bidirectional tapered internal thread 6 is arranged on the inner surface of the cylindrical mother body 2. It is characterized in that the cylindrical mother body 2 includes a nut body 21, and the inner surface of the nut body 21 has spirally distributed the tapered hole 4, the tapered hole 4 includes a bidirectional tapered hole 41, the cylindrical mother body 2 includes a cylindrical body and/or a non-cylindrical body and other workpieces and objects that need to be processed with internal threads on its inner surface.

The described dumbbell-like 94 bi-direction tapered hole 41 is characterized in that is made up of two tapered holes 41 with the same bottom surface and the same top surface but different cone heights. The top surface is symmetrical and mutually joined in a spiral shape to form a thread. The bottom surface is at the two ends of the bi-direction tapered hole 41 and forms a dumbbell-shaped asymmetrical bidirectional tapered threads 1, including the mutual engagement respectively with the lower bottom surfaces of the adjacent bidirectional tapered holes 41 and/or the mutual engagement respectively with the lower bottom surfaces of the adjacent bidirectional tapered holes 41 to form a screw thread. The internal thread 6 includes the first helical conical surface 421 of the tapered hole and a second helical conical surface 422 of the tapered hole and an inner spiral 5, in the section passing through the thread axis 02, its complete single-section asymmetrical bidirectional tapered internal thread 6 is a dumbbell-like 94 special bidirectional tapered geometry with a small middle and large ends and a left taper greater than the right taper. The bidirectional tapered hole 41 includes a bidirectional tapered hole conical surface 42, the left side of the conical surface is the first spiral conical surface 421 of the tapered hole, the angle formed by two plain wire is the first cone angle α1, the first spiral conical surface 421 of the tapered hole forms a left taper 95 and is distributed to the right 98. The right conical surface is the second spiral cone surface 422 of the tapered hole. The angle formed by the two plain wire is the second cone angle α2, the second spiral conical surface 422 of the tapered hole forms a right taper 96 and is distributed to the left 97. The first taper angle α1 and the second taper angle α2 correspond to the taper directions. The plain wire is the intersection of the cone surface and the plane passing through the cone axis 01. The shape formed by the first helical conical surface 421 of the tapered hole and the second helical conical surface 422 of the tapered hole of the bidirectional tapered hole 41 is the same as that of the lower base and the upper base that coincide with the central axis of the cylindrical mother body 2. The upper bases of the two right-angled trapezoids with different right-angle sides are symmetrical and oppositely joined. The shape of the spiral outer surface of the spiral body formed by the two oblique sides of the right-angle trapezoidal combination is the same. The right-angled trapezoidal combined body refers to the upper bottom of two right-angled trapezoids with the same lower base and the same upper base but different right angle sides. A special geometric body with symmetrical sides and joints facing each other, and the bottom sides are respectively at the two ends of the right-angled trapezoidal combined body.

When the bidirectional tapered internal thread and the traditional thread is connected with the transmission, through the screw connection and the bidirectional load of the bidirectional tapered hole 41 and the traditional external thread 9 special cone 7. When the external thread 9 and the internal thread 6 form a thread pair 10, there must be clearance 101 between the bidirectional tapered hole 41 and the special cone 7 of the traditional external thread 9. If there is oil and other media lubrication between the internal thread 6 and the external thread 9, it will easily form a bearing oil film. The clearance 101 is conducive to the formation of the bearing oil film. Thread connect set 10 is equivalent to a group of sliding bearing pairs composed of one pair and/or several pairs of sliding bearings, that is, each section of bidirectional tapered internal thread 6 bidirectionally contains a section of traditional external thread 9 to form a pair of sliding bearings, the number of sliding bearings composed is adjusted according to the application conditions, that is, the effective bidirectional engagement of the bidirectional tapered internal thread 6 and the traditional external thread 9, that is, the number of contained and contained thread sections for effective bidirectional contact engagement, designed according to the application conditions, contain the special cone 7 of traditional external thread 9 through the tapered internally threaded tapered hole 4 and position in the radial, axial, angular and circumferential directions, etc. It constitutes a special composite technology of cone pair and thread pair to ensure the accuracy, efficiency and reliability of the tapered thread technology, especially the bidirectional tapered internal thread and the traditional thread transmission.

When the bidirectional tapered internal thread and the traditional thread is fastened and sealed with the traditional thread, its technical performance is realized by the screw connection of the tapered internal threaded bidirectional tapered hole 41 and the traditional external thread 9 special cone 7, that is, it is achieved by the first helical conical surface 421 of the tapered hole and the special conical surface 72 of the traditional external thread 9 are sized until the interference and/or the second helical cone surface 422 of the tapered hole and the special cone surface 7 of the traditional external thread 9 are sizing until the interference. According to the application conditions, load in one direction and/or load in two directions simultaneously, that is, the bidirectional tapered hole 41 and the traditional external thread 9 special cone 7 is guided by the spiral line, the inner cone and the outer cone inner and outer diameter are centered until the first helical cone surface 421 of the tapered hole is entangled with the special cone surface 72 of the traditional external thread 9 special cone 7 until the interference contact and/or the second helical conical surface 422 of the tapered hole and the special conical surface 72 of the traditional external thread 9 special cone 7 are held until interference contact, so as to realize the technical performance of mechanical mechanism connection, locking, anti-loosening, bearing, fatigue and sealing and so on.

Therefore, this bidirectional tapered internal thread and the traditional thread connection structure 10 mechanical mechanism transmission accuracy, efficiency, bearing capacity, self-locking force, anti-loosening capacity, sealing performance and other technical performance are related to the size of the first helical conical surface 421 of the tapered hole and the left taper 95 formed by it is the size of the corresponding first cone angle α1, and the size of the second helical conical surface 422 of the tapered hole and the right taper 96 formed by it is its corresponding second Cone angle α2. It is also related to the special external taper surface 72 of the special cone 7 of the traditional external thread 9 formed by contacting the internal thread of the bidirectional tapered thread 6 and its taper. The material friction coefficient, processing quality and application conditions of the columnar body 3 and the cylindrical mother body 2 also have a certain influence on the cone fit.

The bidirectional tapered internal thread and the traditional thread, when the right-angled trapezoidal combined body makes one revolution at a constant speed, the axial movement distance of the right-angled trapezoidal combined body is that at least one time the length of the sum of the right-angled sides of two right-angled trapezoids with the same bottom base and the same upper base but different right-angled sides. This structure ensures that the first helical conical surface 421 of the tapered hole and the second helical conical surface 422 of the tapered hole have sufficient length, thereby ensuring that the conical surface 42 of the bi-directional tapered hole has sufficient effective contact area and strength and the efficiency required for spiral motion when matched with the special conical surface 72 of the special cone of the traditional external thread.

The bidirectional tapered internal thread and the traditional thread, when the right-angled trapezoidal combined body makes one revolution at a constant speed, the axial movement distance of the right-angled trapezoidal combined body is that at least one time the length of the sum of the right-angled sides of two right-angled trapezoids with the same bottom base and the same upper base but different right-angled sides. This structure ensures that the first helical conical surface 421 of the tapered hole and the second helical conical surface 422 of the tapered hole have sufficient length, thereby ensuring that the conical surface 42 of the bi-directional tapered hole has sufficient effective contact area and strength and the efficiency required for spiral motion when matched with the special conical surface 72 of the special cone of the traditional external thread.

In the bidirectional tapered internal thread and the traditional thread, the first spiral conical surface 421 of the tapered hole and the second spiral conical surface 422 of the tapered hole are both continuous spiral surfaces or discontinuous spiral surfaces.

With the bidirectional tapered internal thread and the traditional thread, one end and/or both ends of the columnar mother body 3 can be screwed into the connecting hole of the cylindrical mother body 2, and the connecting hole is provided on the nut body 21 threaded hole.

Compared with the existing technology, the advantages of the connection structure of the bi-directional tapered internal thread and the traditional thread pair 10 are: reasonable design, simple structure, bi-directional load-bearing or straight sizing of the cone pair formed by the inner and outer cone coaxial inner and outer diameter centering up to interference fit to realize the fastening and connection functions, convenient operation, large locking force, large load-bearing value, good anti-loosening performance, high transmission efficiency and precision, good mechanical sealing effect, good stability, and can prevent occurrence of connection loose phenomenon, with self-locking and self-positioning functions.

### Embodiment Two

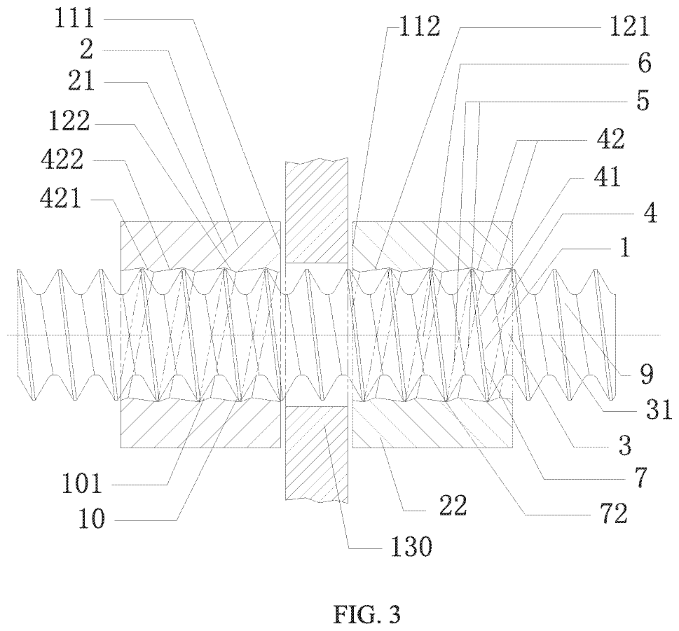

As shown in FIG. 3, the structure, principle, and implementation steps of this embodiment are similar to those of the first embodiment. The difference is that this embodiment adopts an asymmetric bidirectional tapered internal thread 6 double nut and a traditional external thread 9 bolt connection structure. The cylindrical mother body 2 includes a double nut, that is, a nut body 21 and a nut body 22. The nut body 21 is located on the left side of the workpiece 130 to be fastened, and the nut body 22 is located on the right side of the workpiece 130 to be fastened. When the nut is working, the relationship with the workpiece 130 to be fastened is a rigid connection. The rigid connection means that the nut end face supporting surface and the workpiece 130 supporting surface are mutually supporting surfaces, including the locking supporting surface 111 and the locking supporting surface 112. The workpiece 130 refers to a connected object including the workpiece 130.

The thread working support surface of this embodiment is different, including the tapered thread support surface 121 and the tapered thread support surface 122. When the cylindrical mother body 2 is located on the left side of the fastened workpiece 130, that is, the left side of the fastened workpiece 130, and when the cylindrical mother body 2, that is, the right end surface of the left nut body 21 is the locking support surface 111 of the left nut body 21 and the workpiece 130 to be fastened, the left nut body 21 is the left screw of the bidirectional taper thread 1 conical surface is a threaded working bearing surface, that is, tapered threaded bearing surface 122 is a threaded working bearing surface, that is, tapered internal thread 6 tapered hole first spiral conical surface 421 and traditional external thread 9 special conical surface 72 is tapered thread The supporting surface 122 and the first spiral conical surface 421 of the tapered hole and the special conical surface 72 of the traditional external thread 9 are mutually supporting surfaces. When the cylindrical matrix 2 is located on the right side of the workpiece 130 to be fastened, that is, the right side of the workpiece 130 to be fastened. When the side end surface, the cylindrical body 2, that is, the left end surface of the right nut body 22 is the locking bearing surface 112 of the right nut body 22 and the workpiece 130 to be fastened, the right nut body 22 is the right side of the bidirectional taper thread 1 The helical conical surface is the threaded working bearing surface, that is, the tapered thread bearing surface 121 is the threaded working bearing surface, that is, the tapered internal thread 6 the tapered hole, the second helical conical surface 422 and the traditional external thread 9 the special conical surface 72 is tapered The threaded supporting surface 121 and the second spiral conical surface 422 of the tapered hole and the special conical surface 72 of the traditional external thread 9 are mutually supporting surface.

The connecting holes are arranged in the nut body 21 and the nut body 22.

### Embodiment Three

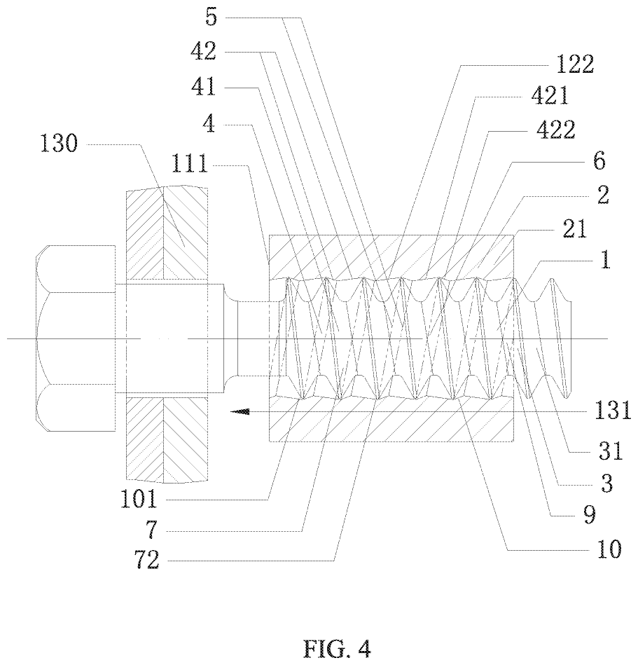

As shown in FIG. 4, the structure, principle and implementation steps of this embodiment are similar to those of the first and second embodiments. The different is this embodiment adopts a connection structure of a traditional threaded bolt and a single nut with asymmetric bidirectional tapered thread 1 and the bolt body has a hexagonal head larger than the screw body 31. When the hexagonal head of the bolt is located on the left side, the cylindrical mother body 2 is the nut body 21, that is, the single nut is located on the right side of the fastened workpiece 130. When a single nut and thread bolt works, the relationship with the workpiece 130 to be fastened is a rigid connection. The rigid connection means that the end face of the nut body 21 and the end face of the workpiece 130 are mutually supporting surfaces, and the supporting surface is a locking supporting surface 111, the workpiece 130 refers to the connected object including the workpiece 130

The threaded working support surface of this embodiment is the tapered threaded support surface 122, that is, the cylindrical mother body 2 or the nut body 21, that is, the single nut is located on the right side of the workpiece 130 to be fastened. When the bolt and single nut work, the right side end surface of the workpiece 130 and the left end surface of the nut body 21 are the locking bearing surface 111 of the nut body 21 and the workpiece 130 to be fastened, and the right helical conical surface of the nut body 21 of bidirectional tapered thread 1 is the threaded working bearing surface, that is, the tapered thread bearing surface 122 is the working bearing surface of the bidirectional tapered thread 1, that is, the tapered internal thread 6 of the second helical conical surface 422 of the tapered hole and the traditional external thread 9 special conical surface 72 is the tapered thread bearing surface 122 and the tapered hole of the double helical conical surface 422 and the special conical surface 72 of the traditional external thread 9 are mutually supporting surfaces.

In this embodiment, when the hexagon head of the bolt is located on the right side, its structure, principle and implementation steps are similar to this embodiment.

### Embodiment Four

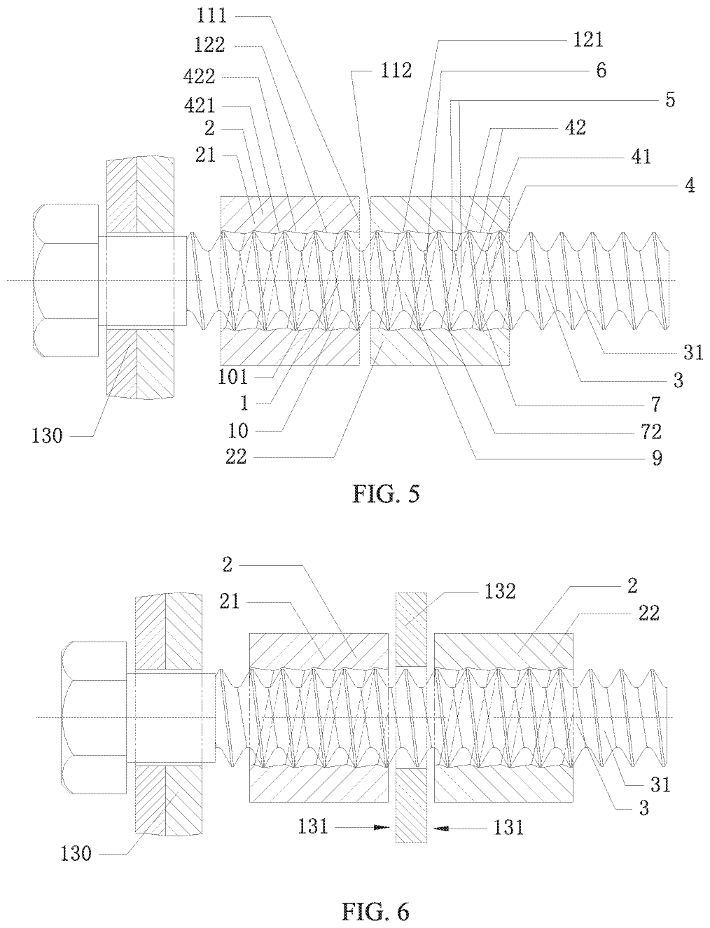

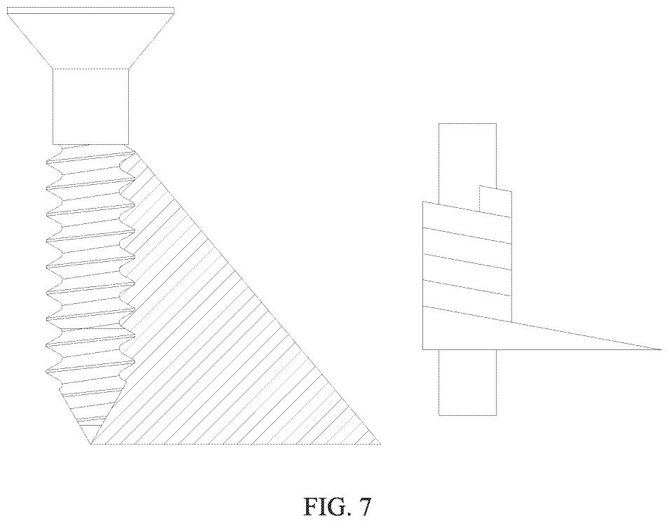

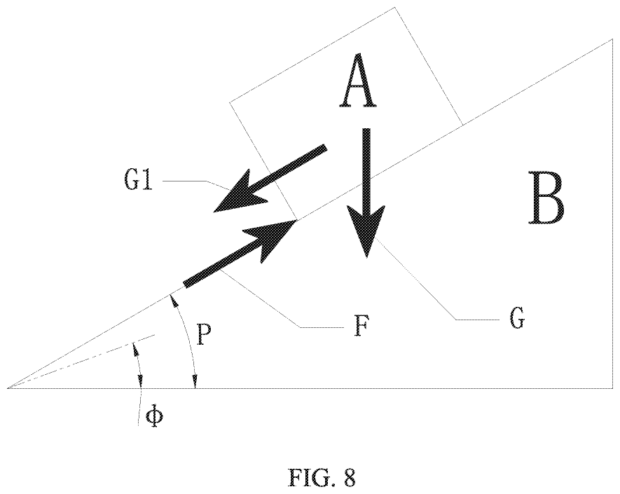

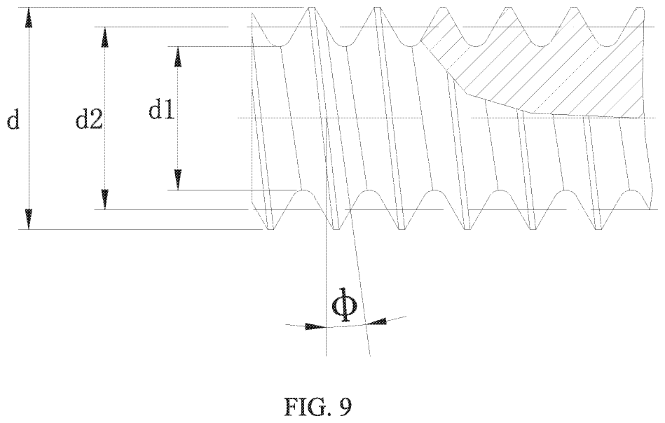

As shown in FIG. 5, the structure, principle, and implementation steps of this embodiment are similar to those of the first and second embodiments. The difference is that the positional relationship between the double nut and the workpiece 130 to be fastened is different. The double nut includes the nut body 21 and the nut body 22 and the bolt body has a hexagonal head larger than the screw body 31. When the bolt's hexagonal head is on the left side, the nut body 21 and the nut body 22 are both on the right side of the workpiece 130 to be fastened. When the nut and bolt is working, the relationship between the nut body 21, the nut body 22 and the workpiece 130 to be fastened is a non-rigid connection. The non-rigid connection means that the two nuts, namely the nut body 21 and the nut body 22, have their opposite side end faces mutually the supporting surface, which includes a locking supporting surface 111 and a locking supporting surface 112, is mainly used in non-rigid materials or transmission parts and other non-rigid connection workpieces 130 or in application fields such as double nut installation to meet requirements. The workpiece 130 refers to a connected object including the workpiece 130.

The thread working support surface of this embodiment is different, including a tapered thread support surface 121 and a tapered thread support surface 122. The cylindrical mother body 2 includes a left nut body 21 and a right nut body 22. The left nut body 21 right side end surface, namely the locking support surface 111, and the left end surface of the right nut body 22, namely the locking support surface 112, are in direct contact with each other and act as locking support surfaces. When the right end surface of the left nut body 21 is the locking support surface 111, the left side of the nut body 21 bidirectional tapered thread 1 on the left side helical conical surface is the threaded working bearing surface, that is, the tapered thread bearing surface 122 is the threaded working bearing surface, that is, the tapered internal thread 6 of the tapered hole first spiral shape conical surface 421 and the special conical surface 72 of the traditional external thread 9 are the bearing surface 122 of the tapered thread, and the first helical conical surface 421 of the tapered hole and the special conical surface 72 of the traditional external thread 9 are mutually supporting surfaces. When the left end surface of the right side of the nut body 22 is the locking support surface 112, the right side helical conical surface of the bidirectional tapered thread 1 of the right nut body 22 is, the threaded working bearing surface, that is, the tapered threaded bearing surface is 121 is the threaded working bearing surface, that is, the taper of the second spiral conical surface 422 of the tapered hole and the second spiral conical surface 422 of the tapered hole and the traditional external thread 9 are the tapered thread bearing surface 121 and the second spiral conical surface 422 of the tapered hole is the same as the traditional external thread 9 and the special conical surface 72 to support each other.

Furthermore, when the cylindrical mother body 2 on the inner side, that is, the nut body 21 adjacent to the fastened workpiece 130 has been effectively combined with the columnar mother body 3, that is, the internal thread 6 and external thread 9 forming the threaded connect sets 10 are effectively held together. The cylindrical mother body 2 located on the outside, that is, the nut body 22 that is not adjacent to the fastened workpiece 130, can be kept in its original shape and/or removed according to the application conditions, leaving only one nut (for example, the weight of the equipment is required or the double nuts are not required to ensure the reliability of the connection technology and other application fields), the removed nut body 22 is not used as a connecting nut but only used as an installation process nut. The internal thread of the described installation process nut is not only made of bi-directional tapered threads, but also made of one-way tapered threads and other threads that can be screwed with bolt threads, including nut bodies 22 made of traditional threads like triangular threads, trapezoidal threads, and sawtooth threads. To ensure the reliability of the connection technology, the threaded connect set 10 is a closed-loop fastening technology system, that is, the internal thread 6 and the external 9 thread of the threaded connect set 10 are effectively amplexus together. The threaded connect set 10 will become an independent technical system without relying on the third party technical compensation to ensure the technical effectiveness of the connection technology system, that is, even if there is no support from other objects, including the gap between the threaded connect set 10 and the workpiece 130 to be fastened, it will not affect the effectiveness of the threaded connection, which will help greatly reduce the weight of the equipment, remove the dead load, and improve the effective load capacity, braking performance, energy saving and so on. This is the unique thread technology advantage when the connection structure between the bidirectional tapered internal thread and the traditional thread and the workpiece 130 to be fastened is a non-rigid connection or a rigid connection.

In this embodiment, when the hexagon head of the bolt is located on the right side, the nut body 21 and the nut body 22 are both located on the left side of the workpiece 130 to be fastened, and the structure, principle and implementation steps are similar to those of this embodiment.

### Embodiment Five

As shown in FIG. 6, the structure, principle, and implementation steps of this embodiment are similar to those of the first and fifth embodiments. The difference is that in this embodiment, on the basis of the fifth embodiment, a spacer such as a gasket 132 is added between the nut body 21 and the nut body 22, that is, the right end face of the left nut body 21 and the left end face of the right nut body 22 are in indirect contact with each other through the gasket 132, thereby indirectly acting as a locking support surface for each other. That is, the relationship between the right end surface of the left side nut body 21 and the left side end surface of the right side nut body 22 has changed from the direct mutual locking support surface to the indirect mutual locking support surface.

The specific embodiments described herein are merely examples to illustrate the spirit of the present invention. Those skilled in the art to which the present invention pertains can make various modifications or additions to the specific embodiments described or use similar alternatives, but they will not deviate from the spirit of the present invention or exceed the definition of the appended claims range.

Although this article uses more tapered thread 1, cylindrical mother body 2, nut body 21, nut body 22, columnar mother body 3, screw body 31, tapered hole 4, bidirectional tapered hole 41, bidirectional tapered hole conical surface 42, conical hole first spiral conical surface 421, first cone angle α1, conical hole second spiral conical surface 422, second cone angle α2, internal helix 5, internal thread 6, special cone 7, special conical surface 72, external thread 9, dumbbell-like 94, left taper 95, right taper 96, left distribution 97, right distribution 98, thread connect set and/or thread pair 10, clearance 101, self-locking Force, self-locking, self-positioning, pressure, cone axis 01, thread axis 02, mirror image, bushing, shaft, single cone, double cone, cone, inner cone, cone hole, outer cone, cone, cone pair, spiral structure, spiral motion, threaded body, integral unit thread, axial force, axial force angle, anti-axial force, anti-axial force angle, centripetal force, reverse central force, reverse collinear, internal stress, two-way force, one-way force, sliding bearing, sliding bearing pair, locking support surface 111, locking support surface 112, tapered thread support surface 122, tapered thread support surface 121, non-solid space, material entity, workpiece 130, nut body locking direction 131, non-rigid connection, non-rigid material, transmission, gasket 132 and other terms, but do not exclude the possibility of using other terms, the use of these terms is only for more convenient description and explanation of this The essence of the invention, to interpret them as any kind of additional restriction is contrary to the spirit of the invention.

1. A connection structure formed by a dumbbell-shaped bi-directional tapered internal thread having a lager left taper and a smaller right taper and traditional thread, or, a connection structure formed by dumbbell-like (a left taper is greater than a right taper) asymmetric bidirectional taper threaded internal thread and the traditional thread, comprising external thread (9) and internal thread (6) threaded to the external thread (9); wherein the dumbbell-like shape (the taper on the left is greater than the taper on the right) asymmetric bidirectional tapered internal thread (6) complete unit body thread is a kind of dumbbell-like (94) asymmetric bidirectional tapered hole (41) with a spiral shape with small middle ends and large ends and the left taper (95) is greater than the right taper (96), the internal thread (6) threaded body is a cylindrical mother body (2) with a spiral bidirectional tapered hole (41) on the inner surface and exists in the form of “non-solid space”, the externally threaded thread body is a special helical cone formed by the original traditional external threaded (9) dental body on the outer surface of the mother body (3) due to the cohesive contact with the bidirectional tapered internal thread (6), and it exists in the form of “material entity”, the above-mentioned asymmetric bidirectional left taper of the tapered internal thread (6) forms a left taper (95) corresponding to the first taper angle (al), and the right taper forms a right taper (96) corresponding to the second taper angle (α2), the taper (95) and the right taper (96) are opposite to each other and the taper is different, the above-mentioned internal thread (6) and external thread (9) pass through the taper hole to enclose the cone until the inner and outer cones bear each other, the technical performance mainly depends on each other to match the taper surface and taper size of the threaded body, preferably, 0°<first taper angle (α1)<53°, 0°<second taper angle (α2)<53°, for individual special fields, preferably, 53°<The first cone angle (α1)<180°.

2. The connection structure according to claim 1, wherein the dumbbell-like (94) bidirectional taper internal thread (6) includes the left conical surface of the bidirectional taper hole conical surface (42), that is, the conical hole first spiral conical surface (421) and the right conical surface are the second helical conical surface (422) and inner helix (5) of the conical hole, the first helical conical surface (421) of the conical hole and the second conical hole shape formed by the spiral conical surface (422), that is, the bidirectional spiral conical surface, is the same as the upper side of the two right-angled trapezoids with the same lower base and the same upper base but different right-angled sides, the right-angled side of the right-angled trapezoidal combination with symmetrical bases and oppositely joined is the center of rotation that rotates at a uniform speed in the circumferential direction, and the right-angled trapezoidal combination simultaneously moves along the central axis of the cylindrical mother body (2) at a uniform speed and axially, and the right-angled trapezoidal combination consists of two diagonals, the spiral outer surface of the convolute formed by the edges has the same shape.

3. The connection structure according to claim 2, wherein when the right-angled trapezoidal combined body rotates at a constant speed for one revolution, the axially moving distance of the right-angled trapezoidal combined body is at least the double length of the sum of the two right-angled trapezoidal right-angle sides of the right-angled trapezoidal combined body.

4. The connection structure according to claim 2, wherein when the right-angled trapezoid combined body makes one revolution at a constant speed, the axial movement distance of the right-angled trapezoidal combined body is equal to the length of the sum of two right-angled trapezoidal right-angle sides of the right-angled trapezoidal combined body.

5. The connection structure according to claim 1, characterized in that the left and right conical surfaces of the asymmetric bidirectional tapered internal thread (6) are the first spiral conical surface (421) and the second helical cone surface (422) and the inner helix (5) of the tapered hole are both continuous helical surfaces or discontinuous helical surfaces; the above-mentioned special cone (7) has a special cone surface (72) and a special cone surface (72) all are continuous spiral surface or discontinuous spiral surface.

6. The connection structure according to claim 1, characterized in that the above-mentioned internal thread (6) is composed of two tapered holes (4) with the same bottom surface and the same top surface but different cone heights, and the lower bottom surface is at the two ends of the bidirectional tapered hole (41) and forms a dumbbell-like (94) asymmetrical bidirectional tapered thread (1), the bottom surfaces are mutually joined and/or are respectively joined to the lower bottom surfaces of the adjacent bidirectional tapered holes (41) in a spiral shape to form a dumbbell-like (94) asymmetrical bidirectional tapered internal thread (6).

7. The connection structure according to claim 1, characterized in that above-mentioned traditional thread includes any one of triangular thread, trapezoidal thread, sawtooth thread, rectangular thread, and circular arc thread, but it is not limited to the above, and it can be applied, the traditional thread that adopts and includes the threaded body, that is, the dental body undergoes deformation processing, and such deformation processing is only due to the threaded cooperation with the above-mentioned bidirectional tapered internal thread (6) to comply with the technical spirit of the present invention.

8. The connection structure according to claim 1, characterized in that the above-mentioned bidirectional tapered internal thread (6) has the ability to assimilate the traditional external thread (9) and includes the single-section thread body is an incomplete tapered geometry, that is, the single-section thread body is not the integral unit thread, the traditional external thread (9) after its assimilation is an alienated traditional thread, that is, the thread body is a special form of tapered thread (1), the above-mentioned internal thread (6) and external thread (9) are composed the thread pair (10) is composed of a spiral bidirectional tapered hole (41) and a spiral special cone (7) to form a sectioned cone pair to form a thread pair (10) and a special cone surface (72) and a cone, the first helical cone surface (421) of the shaped hole and the second helical cone surface (422) of the tapered hole are based on the contact surface as the supporting surface and the inner and outer cone inner and outer diameters are centered until the bidirectional cone, the hole conical surface (42) and the special conical surface (72) are entangled to achieve the helical conical surface load in one direction and/or the helical conical surface load in two directions simultaneously and/or until the sizing self-positioning contact and/or until the sizing interference and produce self-locking.

9. The connection structure according to claim 1, wherein when a cylindrical mother body (2) has been effectively combined with a columnar mother body (3), it constitutes the internal thread (6) of the tapered thread connect set (10) and the external threads (9) are effectively entangled together, and the other cylindrical mother body (2) can be removed and/or retained, and the removed cylindrical mother body (2) is used as an installation process nut, the internal thread includes a bidirectional tapered thread (1), It can also be manufactured with unidirectional tapered thread and traditional thread that can be screwed with the columnar mother body (3).

10. The connection structure according to claim 1, wherein the above-mentioned cylindrical mother body (2) includes a cylindrical body and/or a non-cylindrical body and other workpieces and objects that need to be processed with a bidirectional tapered internal thread (6) on its inner surface, The above-mentioned inner surface includes non-cylindrical surface such as cylindrical surface and/or conical surface and other inner surface geometric shapes.
